(19) United States
(12) Patent Application Publication
(10) Pub. No.: US 2002/0136308 A1
(43) Pub. Date: Sep. 26, 2002

(54) MPEG-2 down-sampled video generation

(76) Inventors: Yann Le Maguet, Paris (FR); Guy Normand, Sucy-en-Brie (FR); Ilhem Ouachani, Meaux (FR)

Correspondence Address: Michael E. Marion, c/o U.S. PHILIPS CORPORATION, Intellectual Property Department, 580 White Plains Road, Tarrytown, NY, 10591, US

(21) Appl. No.: 10/028,098

(22) Filed: Dec. 21, 2001

(30) Foreign Application Priority Data
Dec. 28, 2000 (EP) 00403697.6

(51) Int. Cl. H04N 7/12

(52) U.S. Cl. 375/240.25; 375/240.18

(57) ABSTRACT

The invention relates to a method of generating a down-sampled video from a coded video, said down-sampled video being composed of output down-sampled frames having a smaller format than input frames composing said coded video, said input coded video being coded according to a block-based technique and comprising quantized DCT coefficients defining DCT blocks, said method comprising an error decoding step for delivering a decoded data signal from said coded video, said error decoding step comprising at least a variable length decoding sub-step applied to said quantized DCT coefficients in each DCT block for delivering variable length decoded DCT coefficients defining, a prediction step for delivering a motion-compensated signal of a previous output frame, an addition step for adding said decoded data signal to said motion-compensated signal and resulting in said output down-sampled frames. This method is characterized in that the error decoding step also comprises an inverse quantization sub-step performed on a limited number of said variable length decoded DCT coefficients for delivering inverse quantized decoded DCT coefficients, and an inverse DCT sub-step performed on said inverse quantized decoded DCT coefficients for delivering pixel values defining said decoded data signal.

The present invention relates to a method of generating a down-sampled video from a coded video, said down-sampled video being composed of output down-sampled frames having a smaller format than input frames composing said coded video, said input coded video being coded according to a block-based technique and comprising quantized DCT coefficients defining DCT blocks, said method comprising at least:

an error decoding step for delivering a decoded data signal from said coded video, said error decoding step comprising at least a variable length decoding (VLD) sub-step applied to said quantized DCT coefficients in each DCT block for delivering variable length decoded DCT coefficients,

a prediction step for delivering a motion-compensated signal of a previous output frame,

an addition step for adding said decoded data signal to said motion-compensated signal, resulting in said output down-sampled frames.

This invention also relates to a decoding device for carrying out the different steps of said method. This invention may be used in the field of video editing.

The MPEG-2 video standard (Moving Pictures Experts Groups), referred to as ISO/IEC 13818-2 is dedicated to the compression of video sequences. It is widely used in the context of video data transmission and/or storage, either in professional applications or in consumer products. In particular, such compressed video data are used in applications allowing a user to watch video clips thanks to a browsing window or a display. If the user is just interested in watching a video having a reduced spatial format, e.g. for watching several videos on a same display (i.e. mosaic of videos), a decoding of the MPEG-2 video has basically to be performed. For avoiding such expensive decoding of the original MPEG-2 video, in terms of computational load and memory occupancy, followed by a spatial down-sampling, specific video data contained in the compressed MPEG-2 video can be directly extracted for generating the desired reduced video.

The IEEE magazine published under reference 0-8186-7310-9/95 includes an article entitled “On the extraction of DC sequence from MPEG compressed video”. This document describes a method for generating a video having a reduced format from a video sequence coded according to the MPEG-2 video standard.

It is an object of the invention to provide a cost-effective method for generating, from a block-based coded video, a down-sampled video that has a good image quality.

The invention takes the following aspects into consideration.

The MPEG-2 video standard is a block-based video compression standard using both spatial and temporal redundancy of original video frames thanks to the combined use of the motion-compensation and DCT (Discrete Cosine Transform). Once coded according to the MPEG-2 video standard, the resulting coded video is at least composed of DCT blocks containing DCT coefficients describing the original video frames content in the frequential domain, for luminance (Y) and chrominance (U and V) components. To generate a down-sampled video directly from such a coded video, a sub-sampling in the frequential domain must be performed.

In the prior art, each DCT block composed of 8*8 DCT coefficients is converted, after inverse quantization of DCT coefficients, into a single pixel whose value pixel_average is derived from the direct coefficient (DC), according to the following relationship:

pixel_average=DC/8 (Eq.1)

The value pixel_average corresponds to the average value of the corresponding 8*8 block of pixels that has been DCT transformed during the MPEG-2 encoding. This method is equivalent to a down-sampling of original frames in which each 8*8 block of pixels is replaced by its average value. In some cases, and in particular if the original frames contain blocks of fine details characterized by the presence of alternating coefficients (AC) in DCT blocks, such a method may lead to a bad video quality of the down-sampled video frames because said AC coefficients are not taken into consideration in this method, resulting in smoothed frames.

In accordance with the invention, a down-sampled video is generated from an MPEG-2 coded video through processing of a limited number of DCT coefficients in each input DCT block. Each 8*8 DCT block is thus converted, after inverse quantization of DCT coefficients, into a 2*2 block in the pixel domain. To this end, the method according to the invention is characterized in that it comprises:

an inverse quantization sub-step performed on a limited number of said variable length decoded DCT coefficient for delivering inverse quantized decoded DCT coefficients,

an inverse DCT sub-step performed on said inverse quantized decoded DCT coefficients for delivering pixel values defining said decoded data signal.

Such steps are performed on a set of low frequency DCT coefficients in each DCT block including not only the DC coefficient but also AC coefficients. A better image quality of the down-sampled video is thus obtained, because fine details of the coded frames are preserved, contrary to the prior art, where they are smoothed.

Moreover, this invention is also characterized in that the inverse DCT step consists of a linear combination of said inverse quantized decoded DCT coefficients for each delivered pixel value.

Since this inverse DCT sub-step dedicated to obtaining pixels values from DCT coefficients is only performed on a limited number of DCT coefficients in each DCT block, the computational load of such an inverse DCT is limited, which leads to a cost-effective solution.

The invention also relates to a decoding device for generating a down-sampled video from a coded video which comprises means for implementing processing steps and sub-steps of the method described above.

The invention also relates to a computer program comprising a set of instructions for running processing steps and sub-steps of the method described above.

These and other aspects of the invention will be apparent from and elucidated with reference to the embodiments described below.

The particular aspects of the invention will now be explained with reference to the embodiments described hereinafter and considered in connection with the accompanying drawings, in which identical parts or sub-steps are designated in the same manner:

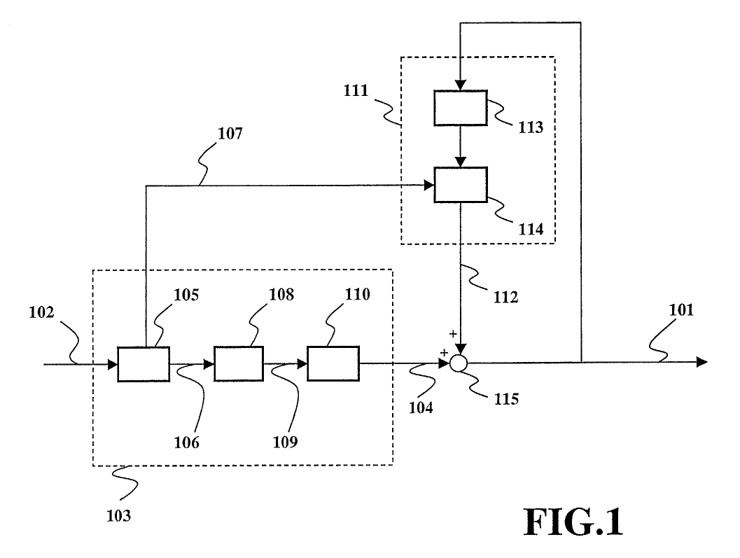

FIG. 1 depicts a preferred embodiment of the invention,

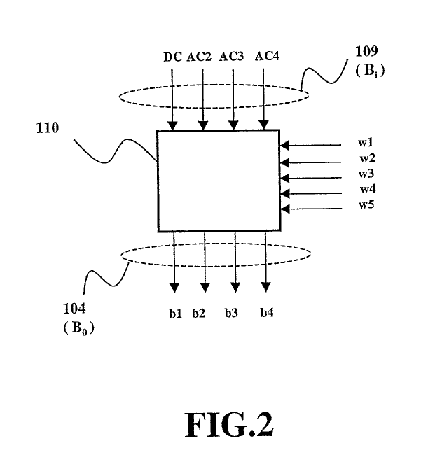

FIG. 2 depicts the simplified inverse DCT according to the invention,

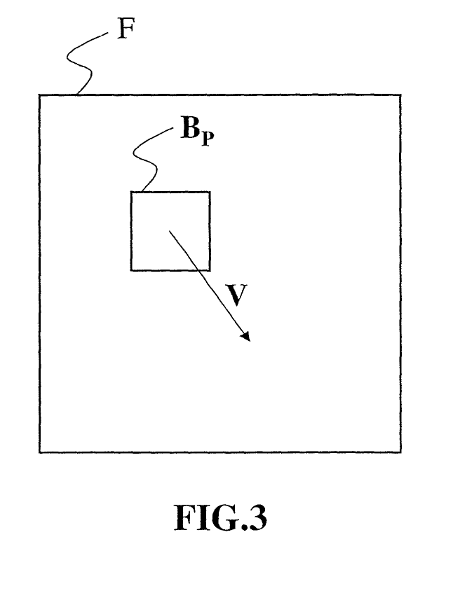

FIG. 3 illustrates the motion compensation used in the invention,

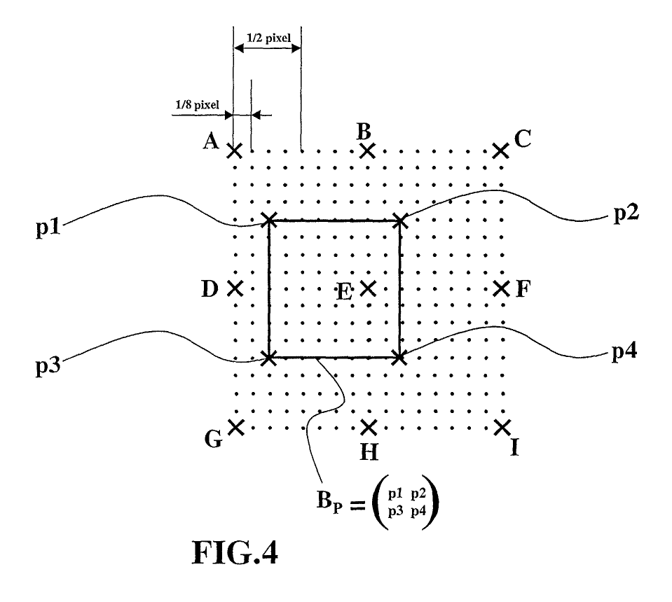

FIG. 4 depicts the pixel interpolation performed during the motion compensation according to the invention.

FIG. 1 depicts an embodiment of the invention for generating down-sampled video frames delivered as a signal 101 and derived from an input video 102 coded according to the MPEG-2 standard. This embodiment comprises an error decoding step 103 for delivering a decoded data signal 104. Said error decoding step comprises:

a variable length decoding (VLD) 105 applied to quantized DCT coefficients contained in a DCT block of the coded video 102 for delivering variable length decoded DCT coefficients 106. This sub-step consists of an entropy decoding (e.g. using a look-up table including Huffman codes) of said quantized DCT coefficients. Thus, an input 8*8 DCT block containing quantized DCT coefficients is transformed by 105 into an 8*8 block containing variable length decoded DCT coefficients. This sub-step 105 is also used for extracting and variable length decoding motion vectors 107 contained in 102, said motion vectors being used for the motion compensation of the last down-sampled frame.

a sub-step 108 performed on said variable length decoded DCT coefficients 106 for delivering inverse quantized decoded DCT coefficients 109. This sub-step is only applied to a limited number of selected variable length decoded DCT coefficients in each input 8*8 DCT block provided by the signal 106 in particular, it is applied to a 2*2 block containing the DC coefficient and its three neighboring low frequency AC coefficients. A down-sampling by a factor 4 is thus obtained horizontally and vertically. This sub-step consists in multiplying each selected coefficient 106 by the value of a quantization step associated with said input 8*8 DCT block, said quantization step being transmitted in data 102. Thus said 8*8 block containing variable length decoded DCT coefficients is transformed by 108 into a 2*2 block containing inverse quantized decoded DCT coefficients.

an inverse DCT sub-step 110 performed on said inverse quantized decoded DCT coefficients 109 for delivering said decoded data signal 104. This sub-step allows to transform the frequential data 109 into data 104 in the pixel domain (also called spatial domain). This is a cost-effective sub-step because it is only performed on 2*2 blocks, as will be explained in a paragraph further below.

This embodiment also comprises a prediction step 111 for delivering a motion-compensated signal 112 of a previous output down-sampled frame. Said prediction step comprises:

a memory sub-step 113 for storing a previous output down-sampled frame through reference to a current frame being down-sampled.

a motion-compensation sub-step 114 for delivering said motion-compensated signal 112 (also called prediction signal 112) from said previous output down-sampled frame. This motion compensation is performed with the use of modified motion vectors derived from motion vectors 107 relative to input coded frames received in 102. Indeed, motion vectors 107 are down-scaled in the same ratio as said input coded frames, i.e. 4, to obtain said modified motion vectors, as will be explained in detail in a paragraph further below.

An adding sub-step 115 finally adds said motion-compensated signal 112 to said decoded data signal 104, resulting in said down-sampled video frames delivered by signal 101.

FIG. 2 depicts the inverse DCT sub-step 110 according to the invention.

As was noted above, only four DCT coefficients (DC, AC2, AC3, AC4) from each 8*8 input block are inverse quantized by sub-step 108, resulting in 2*2 blocks containing inverse quantized DCT coefficients 109, said 2*2 blocks containing inverse quantized DCT coefficients which have to be passed through an inverse DCT to get 2*2 blocks of pixels.

Usually, inverse DCT algorithms are performed on 8*8 blocks containing DCT coefficients, leading to complex and expensive calculations. In the case where only four DCT coefficients are considered, an optimized solution is obtained for performing a cost-effective inverse DCT for generating 2*2 blocks of pixels from 2*2 blocks of DCT coefficients.

Said 2*2 blocks containing inverse quantized DCT coefficients are represented below by an 8*8 matrix Bᵢ containing said DCT coefficients (DC, AC2, AC3, AC4) surrounded by zero coefficients:

$${B}_{i} = ( \begin{matrix}D C & A {C}_{2} & 0 & 0 & 0 & 0 & 0 & 0 \\ A {C}_{3} & A {C}_{4} & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix} )$$

The 2*2 block of pixels resulting from said optimized inverse DCT will be written B₀, B₀, defining a 2*2 matrix containing pixels b1, b2, b3 and b4:

$${B}_{o} = ( \begin{matrix}{\dot{b}}_{1} & {b}_{2} \\ {b}_{3} & {b}_{4}\end{matrix} )$$

Let X⁻¹ be the inverse of matrix X,

Let X^{t} be the transposed value of matrix X.

The DCT of a square matrix A, resulting in matrix C, can be calculated through matrix processing in defining a matrix M, so that:

DCT(A)=C=M.A.M^{t} (Eq.2)

The matrix M is defined by:

$$M ( r , c ) = \{ \begin{matrix}\frac{\sqrt{2}}{4} if r = 0 ( first row ) , \\ \frac{1}{2} cos \frac{π r ( 2 c + 1 )}{16} otherwise .\end{matrix}$$

where r and c correspond to the rank of the row and the column of matrix M, respectively.

Since the matrix M is unitary and orthogonal, it verifies the relation M⁻¹=M^{t}. It can thus be derived from Eq.2 that:

A=M^{t}.C.M (Eq.3)

In Eq.3, matrices A and C cannot be directly identified with matrices B₀ and Bᵢ respectively. Indeed, two cases have to be considered, either that Bᵢ is issued from a field coding or from a frame coding. To this end, the matrix B₀ is derived from the following equation:

B₀=U.A.T^{t} (Eq.4)

The matrices U and T, defined below according to the Bᵢ coding type, allow to define the matrix of pixels B₀ as:

B₀=U.M^{t}.Bᵢ.M.T^{t} (Eq.5)

If Bᵢ is derived from a frame coding:

$$\begin{matrix}U = \frac{1}{4} ( \begin{matrix}1 & 0 & 1 & 0 & 1 & 0 & 1 & 0 \\ 0 & 1 & 0 & 1 & 0 & 1 & 0 & 1\end{matrix} ) \\ T = \frac{1}{4} ( \begin{matrix}1 & 1 & 1 & 1 & 0 & 0 & 0 & 0 \\ 0 & 0 & 0 & 0 & 1 & 1 & 1 & 1\end{matrix} )\end{matrix}$$

The pixels values of B₀ can thus be calculated from Eq.5 as a linear combination of the DCT coefficients contained in matrix Bᵢ as follows:

$$\{ \begin{matrix}{b}_{1} = {w}_{1} * D C + {w}_{2} * A {C}_{2} + {w}_{4} * A {C}_{3} + {w}_{5} * A {C}_{4} \\ {b}_{2} = {w}_{1} * D C - {w}_{2} * A {C}_{2} + {w}_{4} * A {C}_{3} - {w}_{5} * A {C}_{4} \\ {b}_{3} = {w}_{1} * D C + {w}_{2} * A {C}_{2} - {w}_{4} * A {C}_{3} - {w}_{5} * A {C}_{4} \\ {b}_{4} = {w}_{1} * D C - {w}_{2} * A {C}_{2} - {w}_{4} * A {C}_{3} + {w}_{5} * A {C}_{4}\end{matrix} \qquad ( Eq . 6 )$$

where w1, w2, w4 and w5 are weighting factors as defined below.

If Bᵢ is derived from a field coding:

$$\begin{matrix}U = \frac{1}{4} ( \begin{matrix}1 & 1 & 1 & 1 & 0 & 0 & 0 & 0 \\ 0 & 0 & 0 & 0 & 1 & 1 & 1 & 1\end{matrix} ) \\ T = \frac{1}{4} ( \begin{matrix}1 & 1 & 1 & 1 & 0 & 0 & 0 & 0 \\ 0 & 0 & 0 & 0 & 1 & 1 & 1 & 1\end{matrix} )\end{matrix}$$

The pixels values of B₀ can thus be calculated from Eq.5 as a linear combination of the DCT coefficients contained in matrix Bᵢ as follows:

$$\{ \begin{matrix}{b}_{1} = {w}_{1} * D C + {w}_{2} * A {C}_{2} + {w}_{2} * A {C}_{3} + {w}_{3} * A {C}_{4} \\ {b}_{2} = {w}_{1} * D C - {w}_{2} * A {C}_{2} + {w}_{2} * A {C}_{3} - {w}_{3} * A {C}_{4} \\ {b}_{3} = {w}_{1} * D C + {w}_{2} * A {C}_{2} - {w}_{2} * A {C}_{3} - {w}_{3} * A {C}_{4} \\ {b}_{4} = {w}_{1} * D C - {w}_{2} * A {C}_{2} - {w}_{2} * A {C}_{3} + {w}_{3} * A {C}_{4}\end{matrix} \qquad ( Eq . 7 )$$

where w1, w2, w3 are weighting factor as defined below.

Each pixel coefficient b1, b2, b3 and b4 of the 2*2 matrix B₀ can thus be seen as a linear combination of the DCT coefficients DC, AC2, AC3 and AC4 contained in the DCT matrix Bᵢ, or as a weighted average of said DCT coefficients, the weighting factors w1, w2, w3, w4 and w5 being defined by:

$$\begin{matrix}{w}_{1} = \frac{1}{8} = 0.125 \\ {w}_{2} = \frac{\sqrt{2}}{32} ( cos ( \frac{π}{16} ) + cos ( \frac{3 * π}{16} ) + cos ( \frac{5 * π}{16} ) + cos ( \frac{7 * π}{16} ) ) \approx 0.113 \\ {w}_{3} = \frac{1}{64} {( cos ( \frac{π}{16} ) + cos ( \frac{3 * π}{16} ) + cos ( \frac{5 * π}{16} ) + cos ( \frac{7 * π}{16} ) )}^{2} \approx 0.103 \\ {w}_{4} = \frac{\sqrt{2}}{32} ( cos ( \frac{π}{16} ) + cos ( \frac{5 * π}{16} ) + cos ( \frac{9 * π}{16} ) + cos ( \frac{13 * π}{16} ) ) \approx 0.023 \\ {w}_{5} = \frac{1}{64} ( cos ( \frac{π}{16} ) + cos ( \frac{3 * π}{16} ) + cos ( \frac{5 * π}{16} ) + cos ( \frac{7 * π}{16} ) ) * \\ ( cos ( \frac{π}{16} ) + cos ( \frac{5 * π}{16} ) + cos ( \frac{9 * π}{16} ) + ( \frac{13 * π}{16} ) ) \approx 0.020\end{matrix}$$

The above explanations relate to input frames delivered by signal 102 and coded according to the P or the B modes of the MPEG-2 video standard well known be those skilled in the art. If the input signal 102 corresponds to INTRA frames, the prediction step need not be considered because no motion compensation is needed in this case. In this case, explanations given above for steps 105, 108 and 110 remain valid for generating the corresponding output down-sampled INTRA frame.

This optimized inverse DCT sub-step 110 leads to an easy and cost-effective implementation. Indeed, the weighting factors w1, w2, w3, w4 and w5 can be pre-calculated and stored in a local memory, so that the calculation of a pixel value only requires 3 additions/subtractions and 4 multiplications. This solution is highly suitable for implementation in a signal processor allowing VLIW (Very Long Instruction Words), e.g. in performing said 4 multiplications in a single CPU (Clock Pulse Unit) cycle.

FIG. 3 illustrates the motion compensation sub-step 114 according to the invention. It is described for the case in which a frame motion compensation is performed.

The motion compensation sub-step 114 allows to deliver a motion-compensated signal 112 from a previous output down-sampled frame F delivered by signal 101 and stored in memory 113. In order to build a current down-sampled frame carried out by signal 101, an addition 115 has to be performed between the error signal 104 and said motion-compensated signal 112. In particular, a 2*2 block of pixels defining an area of said current output down-sampled frame, corresponding to the down-scaling of an input 8*8 block of the original input coded video 102, is obtained through adding of a 2*2 block of pixels 104 (called B₀ in the above explanations) to a 2*2 block of pixels 112 (called Bₚ below). Bₚ is called the prediction of B₀:

$${B}_{p} = ( \begin{matrix}{p}_{1} & {p}_{2} \\ {p}_{3} & {p}_{4}\end{matrix} )$$

The block of pixels Bₚ corresponds to the 2*2 block in said previous down-sampled frame F, pointed by a modified motion vector V derived from motion vectors 107 relative to said input 8*8 block through a division of its horizontal and vertical components by 4, i.e. by the same down-sampling ratio as between the format of the input coded video 102 and the output down-sampled video delivered by signal 101. Since said modified motion vector V may lead to decimal horizontal and vertical components, an interpolation is performed on pixels defining said previous down-sampled frame F.

FIG. 4 depicts the pixel interpolation performed during motion compensation sub-step 114 for determining the predicted block Bₚ.

This Figure represents a first grid of pixels (A, B, C, D, E, F, G, H, I) defining a partial area of said previous down-sampled frame F, said pixels being represented by a cross. A sub-grid having a ⅛ pixel accuracy is represented by dots. This sub-grid is used for determining the block Bₚ pointed by vector V, said vector V being derived from motion vector 107 first by dividing its horizontal and vertical component by a factor 4, and second by rounding these new components to the nearest value having a ⅛ pixel accuracy. Indeed, a motion vector 107 having a ½ pixel accuracy will lead to a motion vector V having a ⅛ accuracy. This allows to align B_{P} on said sub-grid for determining the pixel values p1, p2, p3 and p4. These four pixels are determined by a bilinear interpolation technique, each interpolated pixel corresponding to the barycenter weight of its four nearest pixels in the first grid. For example, p1 is obtained by bilinear interpolation between pixels A, B, D and E.

A method of generating a down-sampled video from a coded video according to the MPEG-2 video standard has been described. This method may obviously be applied to other input coded video, for example DCT-based video compression standards such as MPEG-1, H.263 or MPEG-4, without deviating from the scope of the invention.

The method according to the invention relies on the extraction of limited DCT coefficients from the input DCT blocks (accordingly Y, U and V components), followed by a simplified inverse DCT applied to said DCT coefficients.

This invention may be implemented in a decoding device for generating a video having a QCIF (Quarter Common Intermediary File) format from an input video having a CCIR format, which will be useful to those skilled in the art for building a wall of down-sampled videos known as a video mosaic.

This invention may be implemented in several ways, such as by means of wired electronic circuits, or alternatively by means of a set of instructions stored in a computer-readable medium, said instructions replacing at least part of said circuits and being executable under the control of a computer, a digital signal processor or a digital signal co-processor in order to carry out the same functions as fulfilled in said replaced circuits. The invention then also relates to a computer-readable medium comprising a software module that includes computer-executable instructions for performing the steps, or some steps, of the method described above.

1. A method of generating a down-sampled video from a coded video, said down-sampled video being composed of output down-sampled frames having a smaller format than input frames composing said coded video, said input coded video being coded according to a block-based technique and comprising quantized DCT coefficients defining DCT blocks, said method comprising:
an error decoding step for delivering a decoded data signal from said coded video, said error decoding step comprising at least a variable length decoding (VLD) sub-step applied to said quantized DCT coefficients in each DCT block for delivering variable length decoded DCT coefficients,
a prediction step for delivering a motion-compensated signal of a previous output frame,
an addition step for adding said decoded data signal to said motion-compensated signal, resulting in said output down-sampled frames,
characterized in that the error decoding step also comprises:
an inverse quantization sub-step performed on a limited number of said variable length decoded DCT coefficients for delivering inverse quantized decoded DCT coefficients,
an inverse DCT sub-step performed on said inverse quantized decoded DCT coefficients for delivering pixel values defining said decoded data signal.

2. A method of generating a down-sampled video from a coded video as claimed in claim 1, characterized in that the inverse quantization step is performed on a set of DCT coefficients composed of the DC coefficient and its three neighboring low frequency AC coefficients.

3. A method of generating a down-sampled video from a coded video as claimed in claim 1, characterized in that the inverse DCT step consists of a linear combination of said inverse quantized decoded DCT coefficients for each delivered pixel value.

4. A method of generating a down-sampled video from a coded video as claimed in claim 1, characterized in that said prediction step comprises an interpolation sub-step of pixels defining said previous output down-sampled frames for delivering said motion-compensated signal.

5. A decoding device for generating a down-sampled video from a coded video, said down-sampled video being composed of output down-sampled frames having a smaller format than input frames composing said coded video, said input coded video being coded according to a block-based technique and comprising quantized DCT coefficients defining DCT blocks, said decoding device comprising:
decoding means for delivering a decoded data signal from said coded video, said decoding means comprising at least variable length decoding (VLD) means applied to said quantized DCT coefficients in each DCT block for delivering variable length decoded DCT coefficients,
motion-compensation means for delivering a motion-compensated signal of a previous output frame,
addition means for adding said decoded data signal to said motion-compensated signal, resulting in said output down-sampled frames,
characterized in that the decoding means also comprise:
inverse quantization means applied to a limited number of said variable length decoded DCT coefficients for delivering inverse quantized decoded DCT coefficients,
inverse DCT means applied to said inverse quantized decoded DCT coefficients for delivering pixel values defining said decoded data signal.

6. A decoding device for generating a down-sampled video from a coded video as claimed in claim 5, characterized in that the inverse quantization means are performed on a set of DCT coefficients composed of the DC coefficient and its three neighboring low frequency AC coefficients.

7. A decoding device for generating a down-sampled video from a coded video as claimed in claim 5, characterized in that the inverse DCT means consist of a linear combination performed by a signal processor of said inverse quantized decoded DCT coefficients for each delivered pixel value.

8. A decoding device for generating a down-sampled video from a coded video as claimed in claim 5, characterized in that said prediction means comprise interpolation means for pixels defining said previous output down-sampled frames for delivering said motion-compensated signal.

9. A decoding device for generating a down-sampled video from a coded video as claimed in claim 5, characterized in that said decoding means are dedicated to the decoding of input video coded according to the MPEG-2 video standard.

10. A computer program product for a decoding device for generating a down-sampled video from a coded video, which product comprises a set of instructions which, when loaded into said device, causes said device to carry out the method as claimed in claims 1 to 4.
